(19) United States
(12) Patent Application Publication
(10) Pub. No.: US 2026/0051697 A1
(43) Pub. Date: Feb. 19, 2026

(54) CONNECTOR ASSEMBLY

(71) Applicant: SUMITOMO WIRING SYSTEMS, LTD., Mie (JP)

(72) Inventor: Yoshitaka ITO, Mie (JP)

(21) Appl. No.: 19/102,412

(22) PCT Filed: Aug. 2, 2023
(86) PCT No.: PCT/JP2023/028282

§ 371 Date: Feb. 10, 2025

(30) Foreign Application Priority Data
Aug. 15, 2022 (JP) 2022-129267

(51) Int. Cl. H01R 13/627; H01R 13/64

(52) U.S. Cl. CPC H01R 13/6271; H01R 13/64

(57) ABSTRACT

A connector assembly according to one aspect of the present disclosure includes a first connector and a second connector. The first connector includes a first housing and a first terminal. The second connector includes a second housing and a second terminal. The first housing includes a locking-target portion and an abutting-target portion. The second housing includes a lock arm that is engaged with the locking-target portion. The lock arm includes an abutting portion that, when the second housing is moved relative to the first housing with the second housing being inclined relative to the first housing, abuts against the abutting-target portion to prevent the second housing from coming into contact with the first terminal. The lock arm is provided on a side of the second housing in a first width direction that extends along a width direction of the second housing.

### TECHNICAL FIELD

The present disclosure relates to a connector assembly.

### BACKGROUND

Conventionally, there is a connector assembly that includes a first connector and a second connector and functions to prevent so-called prying (see, for example, Patent Document 1). The first connector includes a first housing and a first terminal that is held in the first housing. The second connector includes a second housing that is insertable and fittable in the first housing and a second terminal that is held in the second housing. The second housing includes a lock arm that is engaged with a locking-target portion of the first housing while the second housing is inserted and fitted in the first housing. Specifically, the lock arm is provided at a center of the second housing in a width direction of the second housing. The lock arm includes: a protruding portion that protrudes in a height direction of the second housing from the second housing; an extending portion that extends in a rear end direction of the second housing from the protruding portion; and an engaging claw that protrudes in the height direction of the second housing from the extending portion. The lock arm is configured such that the extending portion is bendable. The lock arm is also configured such that the engaging claw is engageable with the locking-target portion. A pair of guide protrusions are formed inside the first housing. In an outer wall of the second housing, fitting grooves into which the guide protrusions are fitted are formed on opposing sides of the lock arm. Each of the guide protrusions includes an abutting protrusion that extends outward in a width direction of the first housing, and the second housing includes slide engaging grooves that correspond to the abutting protrusions. With this configuration, when the second housing is moved relative to the first housing, with the second housing being inclined relative to the first housing, the abutting protrusions abut against the outer wall of the second housing without being fitted into the slide engaging grooves, which prevents the second housing from coming into contact with the first terminal. With this connector assembly, a situation can be suppressed in which the second housing comes into contact with the first terminal to deform the first terminal.

### PRIOR ART DOCUMENT

### Patent Document

Patent Document 1: JP H06-231824 A

### SUMMARY OF THE INVENTION

### Problems to be Solved

In the connector assembly configured as described above, there may be a case where the lock arm cannot be provided at the center of the second housing in the width direction of the second housing. In this case, there is a problem in that the connector assembly has a large dimension in the width direction due to the slide engaging grooves formed on opposing sides of the lock arm and the abutting protrusions that correspond to the slide engaging grooves.

It is an object of the present disclosure to provide a connector assembly in which it is possible to suppress an increase in size.

### Means to Solve the Problem

A connector assembly according to the present disclosure is a connector assembly including: a first connector; and a second connector, wherein the first connector includes a first housing and a first terminal that is held in the first housing, the second connector includes a second housing that is insertable and fittable in the first housing and a second terminal that is held in the second housing and connectable to the first terminal, the first housing includes a locking-target portion and an abutting-target portion, the second housing includes a lock arm that is engaged with the locking-target portion while the second housing is inserted and fitted in the first housing, the lock arm includes an abutting portion that, when the second housing is moved relative to the first housing with the second housing being inclined relative to the first housing, abuts against the abutting-target portion to prevent the second housing from coming into contact with the first terminal, the lock arm is provided on a side of the second housing in a first width direction that is a one direction that extends along a width direction of the second housing, and the abutting portion protrudes in a second width direction that is a direction opposite to the first width direction in the lock arm.

### Effect of the Invention

With the connector assembly according to the present disclosure, it is possible to suppress an increase in size of the connector assembly.

### BRIEF DESCRIPTION OF THE DRAWINGS

FIG. 1 is a perspective view of a connector assembly according to one embodiment.

FIG. 2 is a partially exploded perspective view of the connector assembly according to the one embodiment.

FIG. 3 is a front view of the connector assembly according to the one embodiment.

FIG. 4 is a front view of a first connector according to the one embodiment.

FIG. 5 is a perspective view of a second connector according to the one embodiment.

FIG. 6 is a side view of the second connector according to the one embodiment.

FIG. 7 is a cross-sectional view taken along the line 7-7 shown in FIG. 3.

FIG. 8 is a cross-sectional view illustrating an operation of the connector assembly according to the one embodiment.

FIG. 9 is a cross-sectional view illustrating an operation of the connector assembly according to the one embodiment.

### DETAILED DESCRIPTION TO EXECUTE THE INVENTION

### Description of Embodiment of the Present Disclosure

First, aspects of an embodiment according to the present disclosure will be listed and described.

[1] A connector assembly according to the present disclosure is a connector assembly including: a first connector; and a second connector, wherein the first connector includes a first housing and a first terminal that is held in the first housing, the second connector includes a second housing that is insertable and fittable in the first housing and a second terminal that is held in the second housing and connectable to the first terminal, the first housing includes a locking-target portion and an abutting-target portion, the second housing includes a lock arm that is engaged with the locking-target portion while the second housing is inserted and fitted in the first housing, the lock arm includes an abutting portion that, when the second housing is moved relative to the first housing with the second housing being inclined relative to the first housing, abuts against the abutting-target portion to prevent the second housing from coming into contact with the first terminal, the lock arm is provided on a side of the second housing in a first width direction that is a one direction that extends along a width direction of the second housing, and the abutting portion protrudes in a second width direction that is a direction opposite to the first width direction in the lock arm.

With the configuration described above, the lock arm includes an abutting portion that, when the second housing is moved relative to the first housing with the second housing being inclined relative to the first housing, abuts against the abutting-target portion to prevent the second housing from coming into contact with the first terminal. Accordingly, the first terminal is protected. In addition, the lock arm is provided on a side of the second housing in a first width direction that is a one direction that extends along a width direction of the second housing, and the abutting portion protrudes in a second width direction that is a direction opposite to the first width direction in the lock arm. Accordingly, an increase in size of the connector assembly is suppressed. That is, when the lock arm is provided on the side of the second housing in the first width direction, and the abutting portion also protrudes in the first width direction in the lock arm, the connector assembly may increase in size in the first width direction. However, it is possible to suppress the increase in size of the connector assembly.

[2] In the connector assembly according to clause [1] described above, the lock arm may include: a protruding portion that protrudes in a height direction of the second housing from a leading end of the second housing that is inserted into the first housing; an extending portion that extends in a rear end direction of the second housing from an upper portion of the protruding portion; and an engaging claw that protrudes in the height direction of the second housing from the extending portion and is engageable with the locking-target portion, and the abutting portion may be provided to extend from an end portion of the protruding portion in a leading end direction of the second housing.

With the configuration described above, the abutting portion is provided to extend from an end portion of the protruding portion of the lock arm in a leading end direction of the second housing. Accordingly, even if an attempt is made to insert the second housing into the first housing, with the second housing being inclined relative to the first housing, the abutting portion first abuts against the abutting-target portion. Thus, even if the distance from an opening of the first housing to the first terminal is shortened, it is possible to prevent the second housing from coming into contact with the first terminal. Accordingly, it is possible to suppress an increase in size of the connector assembly.

[3] In the connector assembly according to clause [2] described above, the abutting portion may be provided to extend along the extending portion from the end portion of the protruding portion in the leading end direction of the second housing.

With the configuration described above, the abutting portion extends along the extending portion from the end portion of the protruding portion in the leading end direction of the second housing. Accordingly, for example, the strength of the base portion of the extending portion can be increased. Accordingly, for example, it is possible to suppress damage to the base portion when the extending portion bent.

[4] In the connector assembly according to clause [2] or [3] described above, an end surface of the protruding portion in the leading end direction of the second housing and an upper surface of the protruding portion may be connected by a chamfered portion.

With the configuration described above, an end surface of the protruding portion in the leading end direction of the second housing and an upper surface of the protruding portion are connected by a chamfered portion. Accordingly, it is possible to smoothly insert the second housing into the first housing.

[5] In the connector assembly according to any one of clauses [1] to [4] described above, the abutting portion may be configured to prevent the second housing from coming into contact with the first terminal even when the lock arm is bent.

With the configuration described above, the abutting portion is configured to prevent the second housing from coming into contact with the first terminal even when the lock arm is bent. Accordingly, for example, even if a force that bends the lock arm is applied, the first terminal is protected.

[6] In the connector assembly according to any one of clauses [1] to [5] described above, the first terminal may include two first terminals that are provided in a width direction of the first housing, the first housing may include a separation wall that is provided between the two first terminals that are provided in the width direction of the first housing, the second housing may include a separation groove in which the separation wall is inserted while the second housing is inserted and fitted in the first housing, and the lock arm may be provided on the side of the second housing in the first width direction relative to the separation groove.

With the configuration described above, the first housing includes a separation wall that is provided between the two first terminals that are provided in the width direction of the first housing. Accordingly, the insulation between the two first terminals that are provided in the width direction of the first housing can be maintained at a high level. Also, the second housing includes a separation groove in which the separation wall is inserted while the second housing is inserted and fitted in the first housing, and thus the second housing can be inserted into the first housing while avoiding the separation wall. With the second housing configured as described above, due to the presence of the separation groove, it is not possible to provide the lock arm at the center of the second housing in the width direction of the second housing. However, by providing the lock arm on the side of the second housing in the first width direction relative to the separation groove, the lock arm can be engaged with the locking-target portion. With the connector assembly configured as described above, the abutting portion protrudes in the second width direction in the lock arm, and it is therefore possible to suppress an increase in size of the connector assembly.

[7] In the connector assembly according to clause [6] described above, the first terminal may include two first terminals that are provided in a height direction of the first housing, the separation wall may include an auxiliary wall that extends in the width direction of the first housing toward between the two first terminals that are provided in the height direction of the first housing, and the second housing may include an auxiliary groove in which the auxiliary wall is inserted while the second housing is inserted and fitted in the first housing.

With the configuration described above, the separation wall includes an auxiliary wall that extends in the width direction of the first housing toward between the two first terminals that are provided in the height direction of the first housing, and the second housing includes an auxiliary groove in which the auxiliary wall is inserted. Accordingly, the contact of the second housing into the first terminal can also be prevented by the auxiliary wall and the auxiliary groove. That is, in the case of a configuration in which two first terminals are provided in the height direction of the first housing, the opening of the first housing has a large dimension in the height direction. In the case of a configuration in which the auxiliary wall and the auxiliary groove are not provided, the second housing is easily inserted deep into the first housing with the second housing being inclined relative to the first housing. However, as a result of the auxiliary wall and the auxiliary groove being provided, it is possible to prevent the second housing from being easily inserted deep into the first housing. Thus, even if the distance from the opening of the first housing to the first terminal is shortened, it is possible to prevent the second housing from coming into contact with the first terminal. Accordingly, it is possible to suppress an increase in size of the connector assembly.

### Detailed Description of Embodiment of the Present Disclosure

A specific example of the connector assembly according to the present disclosure will be described below with reference to the accompanying drawings. In the drawings, for the sake of the convenience of description, some structural elements may be shown in an exaggerated or simplified manner. Also, the dimensional ratio of structural elements may vary from drawing to drawing. The terms such as “parallel”, “perpendicular”, and “perfect circle” used in the specification of the present application not only strictly mean parallel, perpendicular, and perfect circle, but also mean substantially parallel, perpendicular, and perfect circle as long as the actions and advantageous effects of the present embodiment can be obtained. It is to be noted that the present invention is not limited to examples given below, the scope of the present invention is indicated by the appended claims, and all changes that come within the meaning and range of equivalency of the claims are intended to be embraced within the scope of the present invention.

### (Configuration of Connector Assembly 11)

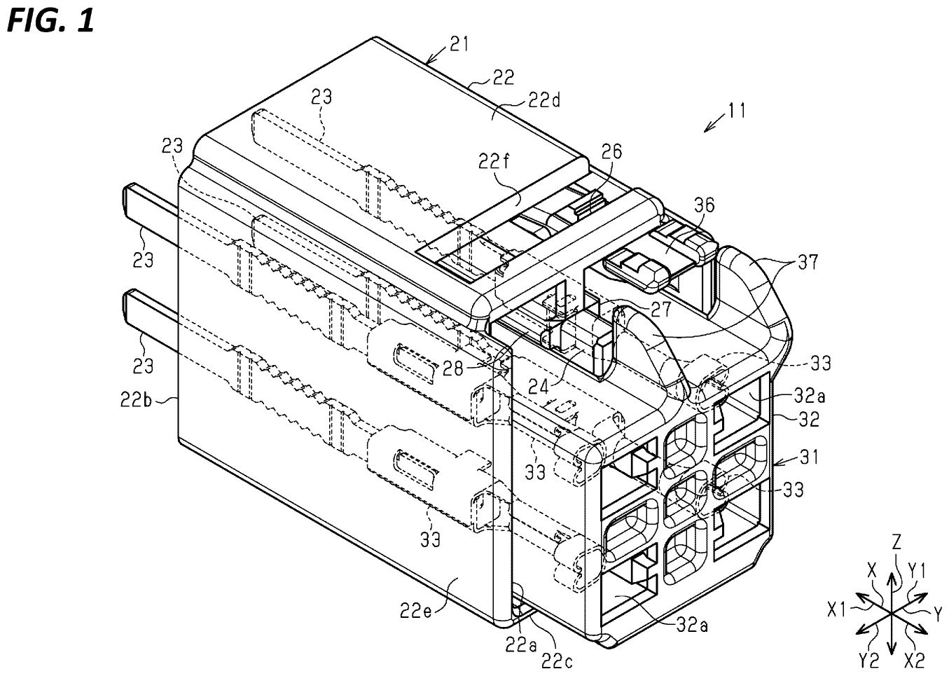

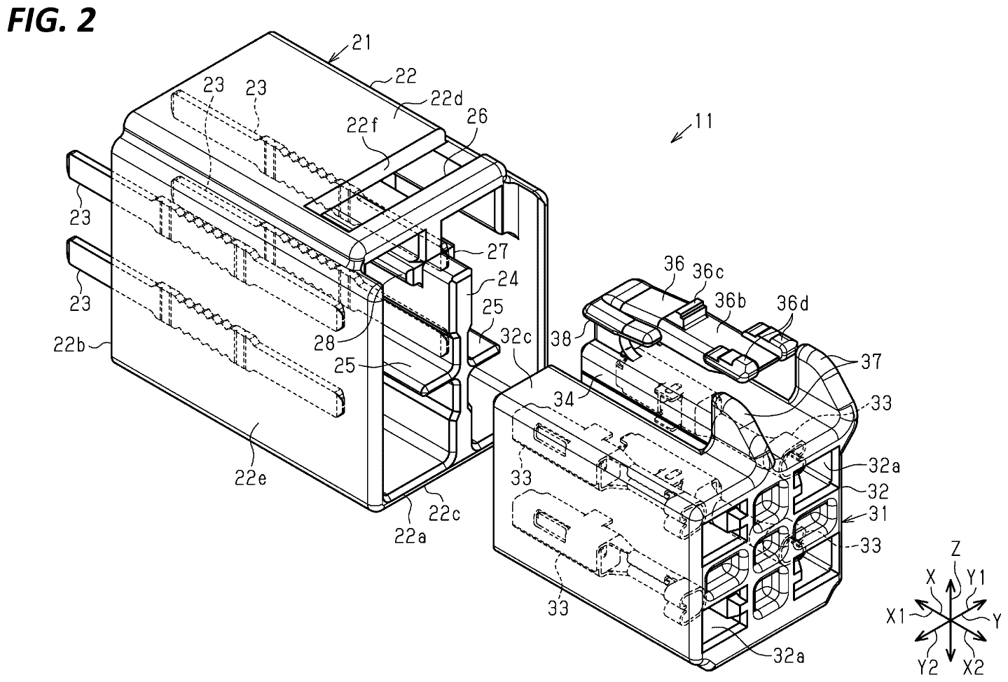

As shown in FIGS. 1 and 2, a connector assembly 11 includes a first connector 21 and a second connector 31 that can be connected to the first connector 21 by being moved relative to the first connector 21 in a first attachment/detachment direction X1 that extends along a first axis X. The connector assembly 11 is interposed in, for example, a path that electrically connects in-vehicle devices mounted on a vehicle. In each diagram, the first axis X, a second axis Y that is perpendicular to the first axis X, and a third axis Z that is perpendicular to the first axis X and the second axis Y are shown. Also, in each diagram, the first attachment/detachment direction X1 that is a one direction that extends along the first axis X and a second attachment/detachment direction X2 that is another one direction that extends along the first axis X and is opposite to the first attachment/detachment direction X1 are shown. Also, in each diagram, a first width direction Y1 that is a one direction that extends along a width direction of the second housing that extends along the second axis Y and a second width direction Y2 that is another one direction that extends along the width direction of the second housing that extends along the second axis Y and is opposite to the first width direction Y1 are shown.

### (Configuration of First Connector 21)

As shown in FIGS. 1 to 4, the first connector 21 includes a first housing 22 and a first terminal 23 that is held in the first housing 22.

The first housing 22 is made using an insulating resin material.

As shown in FIG. 2 and FIGS. 7 to 9, the first housing 22 includes an opening 22a that has a rectangular cylindrical shape and is open in the second attachment/detachment direction X2. Also, the first housing 22 includes a closed portion 22b at an end of the first housing 22 in the first attachment/detachment direction X1. The first terminal 23 is held by the closed portion 22b. The first terminal 23 is a male terminal made of a long metal plate material. The first terminal 23 is embedded in the closed portion 22b through insert molding. The first terminal 23 is provided to extend along the first axis X and also extend through the closed portion 22b.

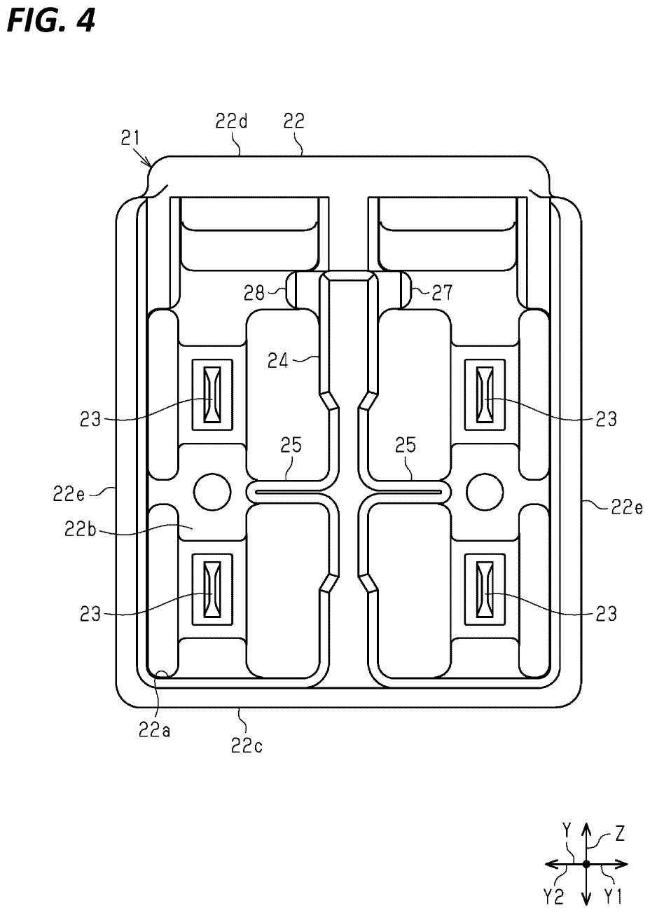

As shown in FIG. 4, two first terminals 23 are provided in a height direction of the first housing 22 that extends along the third axis Z. In addition thereto, two first terminals 23 are provided in a width direction of the first housing 22 that extends along the second axis Y. That is, four first terminals 23 are provided in the first housing 22.

### (Detailed Configuration of First Housing 22)

As shown in FIGS. 2 and 4, the first housing 22 includes a separation wall 24 between the two first terminals 23 that are provided in the width direction of the first housing 22. The separation wall 24 is provided at a center of the first housing 22 in the width direction of the first housing 22. The separation wall 24 is provided to extend along an entire dimension of the first housing 22 in the height direction of the first housing 22 from a bottom wall 22c to an upper wall 22d of the first housing 22. The separation wall 24 is also provided to extend along an entire dimension of the first housing 22 in a lengthwise direction of the first housing 22 from the opening 22a to the closed portion 22b of the first housing 22.

Also, the separation wall 24 includes an auxiliary wall 25 that extends in the width direction of the first housing 22 toward between the two first terminals 23 that are provided in the height direction of the first housing 22. The auxiliary wall 25 is composed of a pair of auxiliary walls 25 that extend from the separation wall 24 toward opposite sides in the width direction of the first housing 22. Each of the pair of auxiliary walls 25 is provided to extend from the separation wall 24 to a midpoint position between the separation wall 24 and each side wall 22e of the first housing 22.

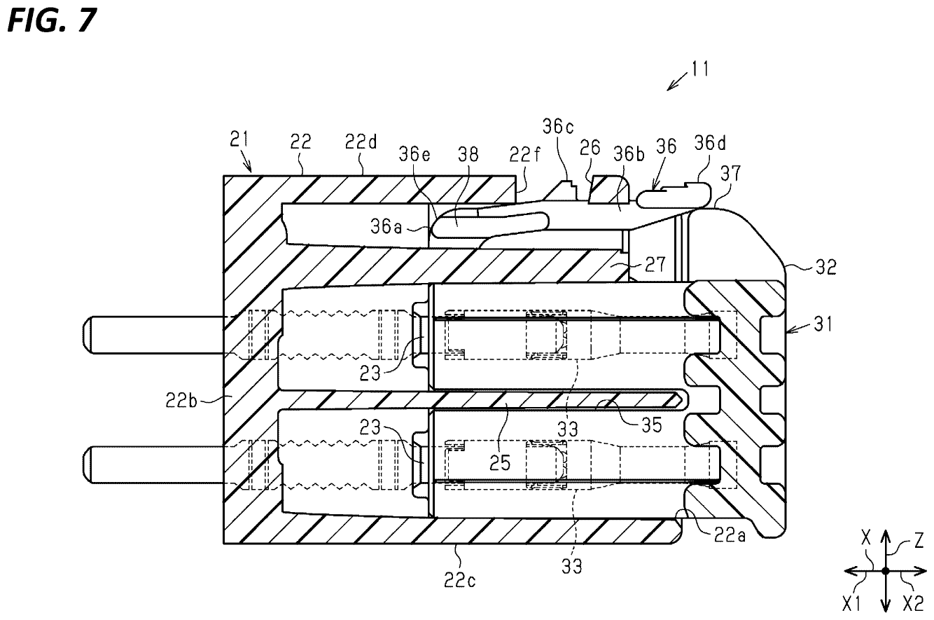

Also, as shown in FIGS. 1 and 7, the first housing 22 includes a locking-target portion 26. The locking-target portion 26 is provided in the upper wall 22d of the first housing 22. The locking-target portion 26 is formed by forming a through hole 22f in the upper wall 22d, and includes an engageable surface in the second attachment/detachment direction X2.

Also, as shown in FIGS. 1 to 4, the first housing 22 includes an abutting-target portion 27. The abutting-target portion 27 is provided on the separation wall 24. The abutting-target portion 27 is provided to extend in the first width direction Y1 that is a one direction that extends in the width direction of the first housing 22 from the separation wall 24 at a position between the auxiliary wall 25 and the upper wall 22d. The abutting-target portion 27 has a length shorter than that of the auxiliary wall 25 and extends in the first width direction Y1.

Also, the first housing 22 includes a symmetric extension portion 28 that is paired with the abutting-target portion 27. The symmetric extension portion 28 is formed to be symmetric to the abutting-target portion 27 about the separation wall 24. That is, the symmetric extension portion 28 is provided on the separation wall 24. The symmetric extension portion 28 is provided to extend in the second width direction Y2, which is a direction opposite to the first width direction Y1, from the separation wall 24 at a position between the auxiliary wall 25 and the upper wall 22d. The symmetric extension portion 28 has a length shorter than that of the auxiliary wall 25 and extends in the second width direction Y2.

### (Configuration of Second Connector 31)

As shown in FIGS. 1 and 2, the second connector 31 includes: a second housing 32 that is insertable and fittable in the first housing 22 by being moved relative to the first housing 22 in the first attachment/detachment direction X1 that extends along the first axis X; and a second terminal 33 that is held in the second housing 32 and is connectable to the first terminal 23.

The second housing 32 is made using an insulating resin material.

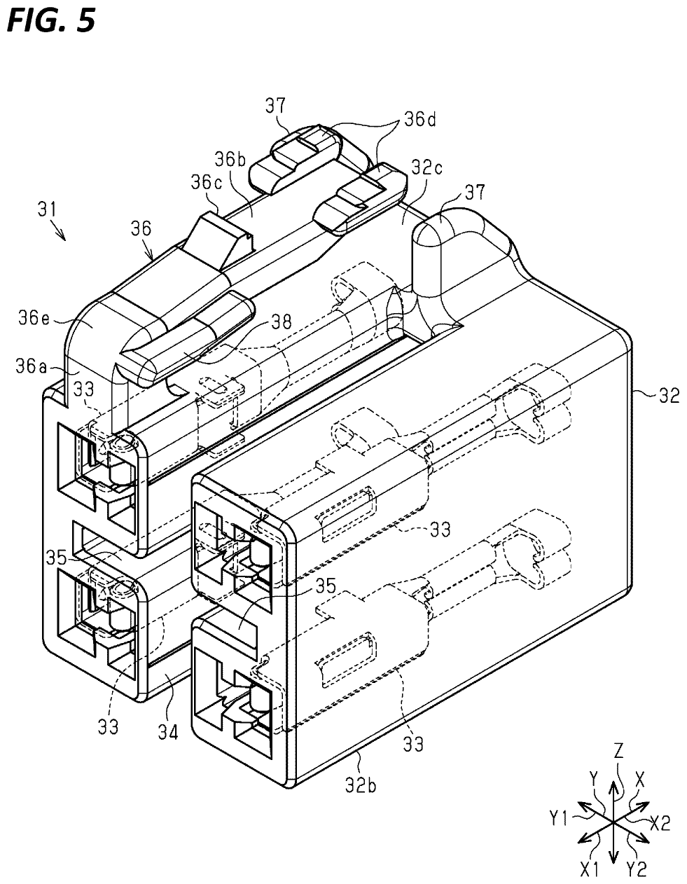

As shown in FIGS. 2 and 5, the second housing 32 has a rectangular prism shape sized to be inserted into the first housing 22. In the second housing 32, the second terminal 33 is held at a corresponding position to the first terminal 23.

Specifically, as shown in FIG. 5, two second terminals 33 are provided in a height direction of the second housing 32 that extends along the third axis Z. In addition thereto, two second terminals 33 are provided in a width direction of the second housing 32 that extends along the second axis Y. That is, four second terminals 33 are provided in the second housing 32.

Each of the second terminals 33 is a female terminal formed by bending a metal plate material. Specifically, in the second housing 32, housing holes 32a (see FIG. 2) are formed at corresponding positions to the first terminals 23. The second terminals 33 are housed and held in the housing holes 32a, respectively. In a state in which the second housing 32 is inserted and fitted in the first housing 22, the second terminals 33 are connected to the first terminals 23 by being fitted to the first terminals 23. In-vehicle devices are connected to the first terminals 23 and the second terminals 33 via terminals, electric wires, or the like (not shown).

### (Detailed Configuration of Second Housing 32)

The second housing 32 includes a separation groove 34 in which the separation wall 24 is inserted while the second housing 32 is inserted and fitted in the first housing 22. The separation groove 34 is formed at a center of the second housing 32 in the width direction of the second housing 32. The separation groove 34 is provided to extend along an entire dimension of the second housing 32 in the height direction of the second housing 32 from a lower surface 32b to an upper surface 32c of the second housing 32. The separation groove 34 is recessed from an end portion of the second housing 32 in the first attachment/detachment direction X1 toward the second attachment/detachment direction X2. In other words, the separation groove 34 is recessed from a leading end of the second housing 32 that is inserted into the first housing 22 toward a rear end of the second housing 32.

Also, the second housing 32 includes an auxiliary groove 35 in which the auxiliary wall 25 is inserted while the second housing 32 is inserted and fitted in the first housing 22. The auxiliary groove 35 is composed of a pair of auxiliary grooves 35 that extend from the separation groove 34 toward opposite sides in the width direction of the second housing 32. Each of the pair of auxiliary grooves 35 is recessed from the leading end of the second housing 32, which is inserted in the first housing 22, toward the rear end of the second housing 32 to the same position as the separation groove 34.

Also, as shown in FIGS. 1 and 7, the second housing 32 includes a lock arm 36 that is engaged with the locking-target portion 26 while the second housing 32 is inserted and fitted in the first housing 22.

The lock arm 36 is provided on a side of the second housing 32 in the first width direction Y1 that is a one direction that extends in the width direction of the second housing 32. The lock arm 36 of the present embodiment is provided on the side of the second housing 32 in the first width direction Y1 relative to the separation groove 34.

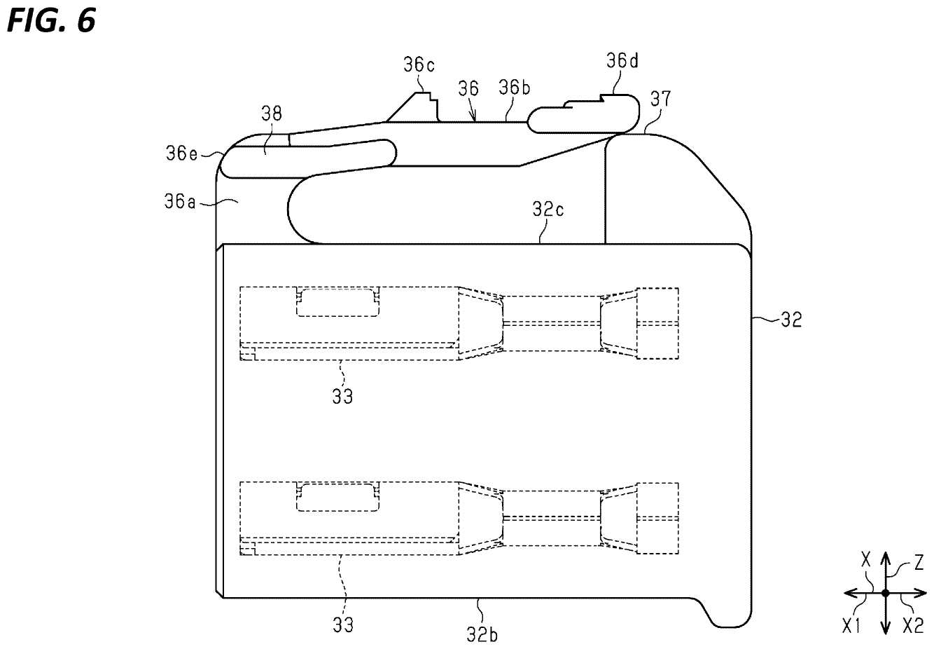

As shown in FIGS. 5 and 6, the lock arm 36 includes a protruding portion 36a, an extending portion 36b, an engaging claw 36c, and an operating portion 36d. The protruding portion 36a protrudes in the height direction of the second housing 32 from the leading end of the second housing 32 that is inserted in the first housing 22. The protruding portion 36a protrudes from the upper surface 32c of the second housing 32. An end surface of the protruding portion 36a in a leading end direction of the second housing 32 and an upper surface of the protruding portion 36a are connected by a chamfered portion 36e. In the present embodiment, the chamfered portion 36e is a curved surface. The extending portion 36b extends in a rear end direction of the second housing 32 from an upper portion of the protruding portion 36a, and is thereby capable of being bent in the height direction of the second housing 32. The engaging claw 36c protrudes in the height direction of the second housing 32 from a middle portion of the extending portion 36b, and is thereby capable of being engaged with the locking-target portion 26 (see FIGS. 1 and 7). The operating portion 36d protrudes in opposite directions of the width direction of the second housing 32 from opposing sides of a leading end portion of the extending portion 36b, and also protrudes in the height direction of the second housing 32. In the second housing 32 of the present embodiment, a pair of protection walls 37 are provided near the operating portion 36d, the pair of protection walls 37 being configured to protrude in the height direction of the second housing 32 from the upper surface 32c of the second housing 32 so as to prevent the operating portion 36d from being accidentally pressed down.

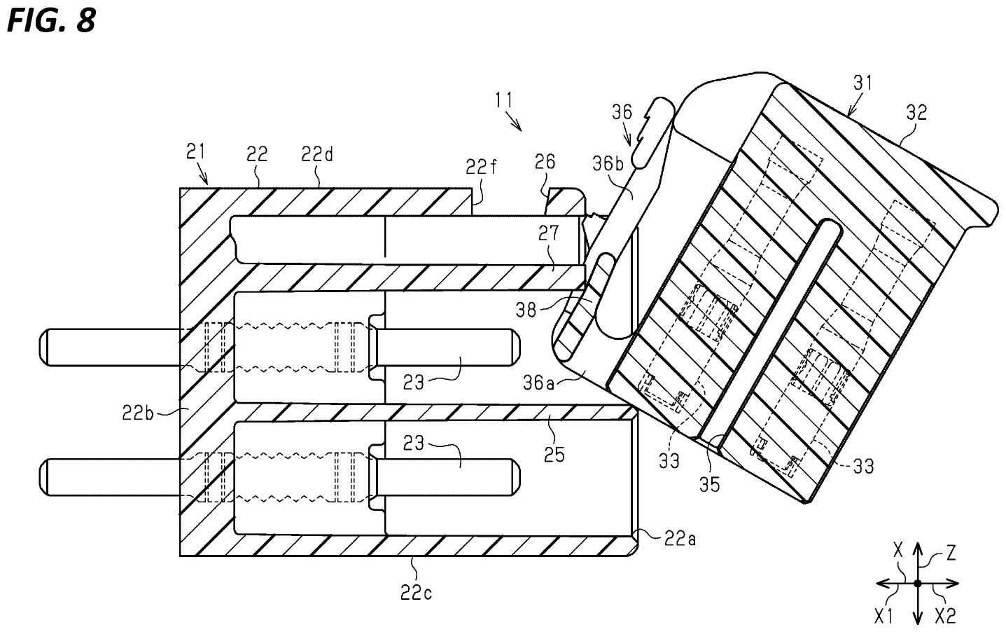

As shown in FIG. 8, the lock arm 36 includes an abutting portion 38 that, when the second housing 32 is moved relative to the first housing 22, with the second housing 32 being inclined relative to the first housing 22, abuts against the abutting-target portion 27 to prevent the second housing 32 from coming into contact with the first terminal 23. That is, the abutting portion 38 is provided to, even if an attempt is made to insert the second housing 32 into the first housing 22, with the second housing 32 being inclined relative to the first housing 22, abut against the abutting-target portion 27 to prevent the second housing 32 from reaching deep into the first housing 22.

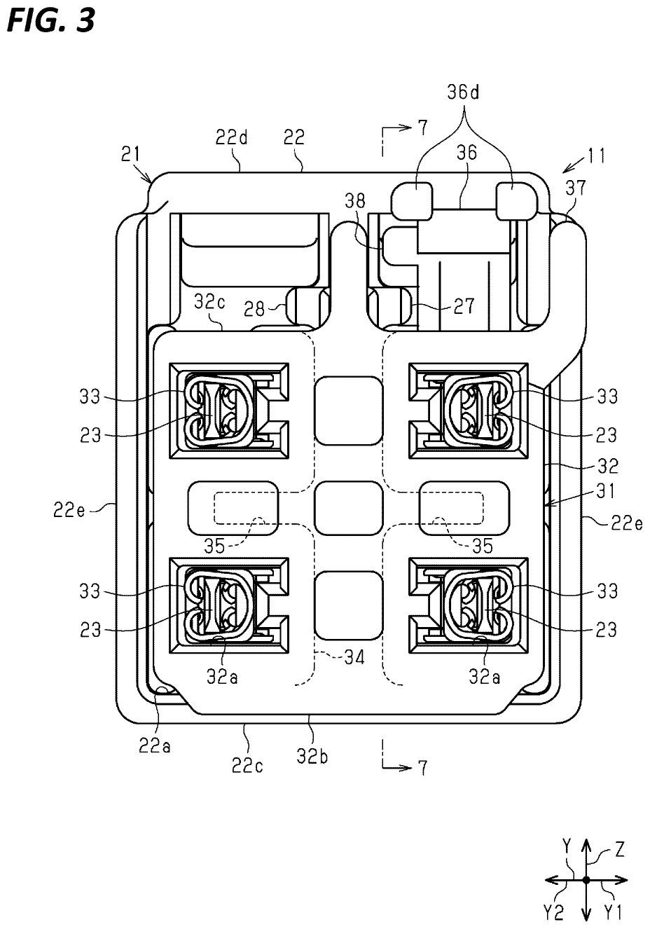

As shown in FIGS. 3 and 5, the abutting portion 38 protrudes in the second width direction Y2 that is a direction opposite to the first width direction Y1 in the lock arm 36.

As shown in FIGS. 5 and 6, the abutting portion 38 is provided to extend from an end portion of the protruding portion 36a in the leading end direction of the second housing 32, or in other words, an end portion of the protruding portion 36a in the first attachment/detachment direction X1. Also, the abutting portion 38 is provided to extend along the extending portion 36b from the end portion of the protruding portion 36a in the leading end direction of the second housing 32. That is, the abutting portion 38 is provided to also function as a reinforcement rib for increasing the strength of the base portion of the extending portion 36b.

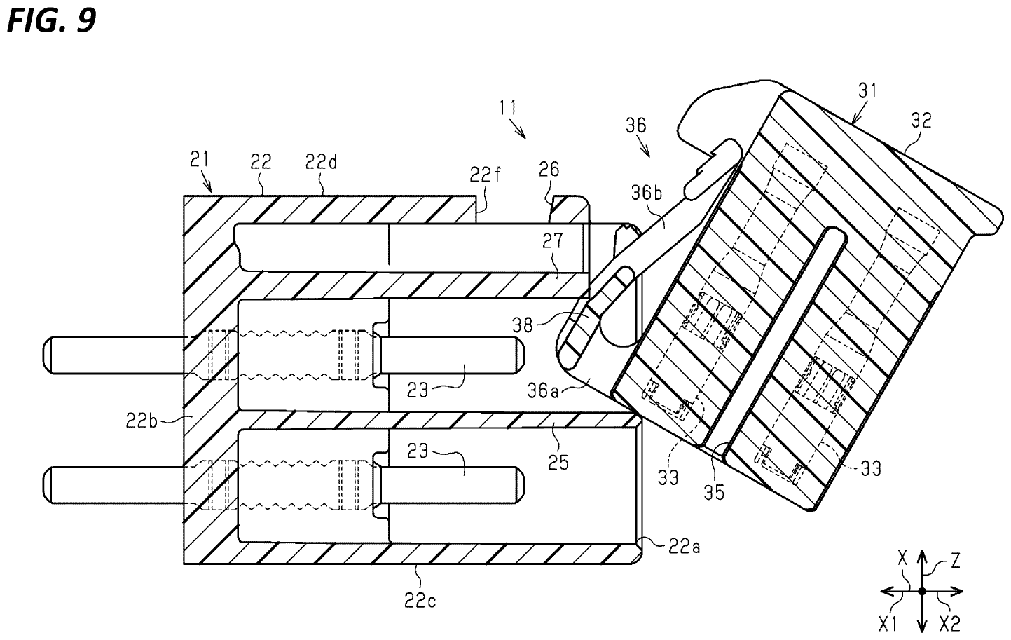

Also, as shown in FIG. 9, the abutting portion 38 is also configured to abut against the abutting-target portion 27 to prevent the second housing 32 from coming into contact with the first terminals 23 even when the lock arm 36 is bent, specifically, even when the extending portion 36b is bent. That is, the abutting portion 38 provided on the lock arm 36 allows the second housing 32 to easily enter the back of the first housing 22 when the lock arm 36 is bent.

In a non-inclined state in which the second housing 32 is not inclined relative to the first housing 22 as shown in FIG. 7, the abutting portion 38 is inserted between the abutting-target portion 27 and the upper wall 22d, which allows the second housing 32 to be inserted and fitted in the first housing 22.

Next, a description will be given of an operation of the connector assembly 11 configured as described above.

As shown in FIGS. 8 and 9, in the connector assembly 11, there may be a case where the second housing 32 is inclined relative to the first housing 22 so as to insert the second housing 32 into the first housing 22 such as, for example, when it is difficult to visually confirm the insertion.

In this case, the abutting portion 38 abuts against the abutting-target portion 27, and thus further insertion of the second housing 32 into the first housing 22 is restricted. With this configuration, it is possible to prevent the second housing 32 from coming into contact with the first terminal 23 and eventually suppress deformation of the first terminal 23.

Next, advantageous effects of the embodiment given above will be described below.

(1) The lock arm 36 includes an abutting portion 38 that, when the second housing 32 is moved relative to the first housing 22 with the second housing 32 being inclined relative to the first housing 22, abuts against the abutting-target portion 27 to prevent the second housing 32 from coming into contact with the first terminal 23, and thus the first terminal 23 is protected. Also, the lock arm 36 is provided on a side of the second housing 32 in a first width direction Y1 that is a one direction that extends along a width direction of the second housing 32, and the abutting portion 38 protrudes in a second width direction Y2 that is a direction opposite to the first width direction Y1 in the lock arm 36. Accordingly, an increase in size of the connector assembly 11 is suppressed. That is, when the lock arm 36 is provided on the side of the second housing 32 in the first width direction Y1, and the abutting portion 38 also protrudes in the first width direction Y1 in the lock arm 36, the connector assembly 11 may increase in size in the first width direction Y1. In contrast, the present embodiment is configured such that the abutting portion 38 protrudes in a second width direction Y2 that is a direction opposite to the first width direction Y1 in the lock arm 36. With this configuration, it is possible to suppress the increase in size of the connector assembly 11.

(2) The abutting portion 38 is provided to extend from an end portion of the protruding portion 36a of the lock arm 36 in a leading end direction of the second housing 32. Accordingly, even if an attempt is made to insert the second housing 32 into the first housing 22, with the second housing 32 being inclined relative to the first housing 22, the abutting portion 38 first abuts against the abutting-target portion 27. Thus, even if the distance from the opening 22a of the first housing 22 to the first terminals 23 is shortened, it is possible to prevent the second housing 32 from coming into contact with the first terminal 23. Accordingly, it is possible to suppress an increase in size of the connector assembly 11.

(3) The abutting portion 38 is provided to extend along the extending portion 36b from the end portion of the protruding portion 36a in the leading end direction of the second housing 32. Accordingly, for example, the strength of the base portion of the extending portion 36b can be increased. Accordingly, for example, it is possible to suppress damage to the base portion when the extending portion 36b is bent.

(4) An end surface of the protruding portion 36a in the leading end direction of the second housing 32 and an upper surface of the protruding portion 36a are connected by a chamfered portion 36e. Accordingly, it is possible to smoothly insert the second housing 32 into the first housing 22.

(5) The abutting portion 38 is configured to prevent the second housing 32 from coming into contact with the first terminal 23 even when the lock arm 36 is bent. Accordingly, for example, even if a force that bends the lock arm 36 is applied, the first terminal 23 is protected.

(6) The first housing 22 includes a separation wall 24 that is provided between two first terminals 23 that are provided in the width direction of the first housing 22. Accordingly, the insulation between the two first terminals 23 that are provided in the width direction of the first housing 22 can be maintained at a high level. Also, the second housing 32 includes a separation groove 34 in which the separation wall 24 is inserted while the second housing 32 is inserted and fitted in the first housing 22, and thus the second housing 32 can be inserted into the first housing 22 while avoiding the separation wall 24. With the second housing 32 configured as described above, due to the presence of the separation groove 34, it is not possible to provide the lock arm 36 at the center of the second housing 32 in the width direction of the second housing 32. However, by providing the lock arm 36 on the side of the second housing 32 in the first width direction Y1 relative to the separation groove 34, the lock arm 36 can be engaged with the locking-target portion 26. With the connector assembly 11 configured as described above, the abutting portion 38 protrudes in the second width direction Y2 in the lock arm 36, and it is therefore possible to suppress an increase in size of the connector assembly 11.

(7) The separation wall 24 includes an auxiliary wall 25 that extends in the width direction of the first housing 22 toward between two first terminals 23 that are provided in a height direction of the first housing 22, and the second housing 32 includes an auxiliary groove 35 in which the auxiliary wall 25 is inserted. Accordingly, the contact of the second housing 32 into the first terminal 23 can also be prevented by the auxiliary wall 25 and the auxiliary groove 35. That is, in the case of a configuration in which two first terminals 23 are provided in the height direction of the first housing 22, the opening 22a of the first housing 22 has a large dimension in the height direction. In the case of a configuration in which the auxiliary wall 25 and the auxiliary groove 35 are not provided, the second housing 32 is easily inserted deep into the first housing 22 with the second housing 32 being inclined relative to the first housing 22. However, as a result of the auxiliary wall 25 and the auxiliary groove 35 being provided, it is possible to prevent the second housing 32 from being easily inserted deep into the first housing 22. Thus, even if the distance from the opening 22a of the first housing 22 to the first terminal 23 is shortened, it is possible to prevent the second housing 32 from coming into contact with the first terminal 23. Accordingly, it is possible to suppress an increase in size of the connector assembly 11.

The present embodiment can be carried out by making changes as described below. The present embodiment and the following variations can be combined and carried out as appropriate unless they are technically contradictory to each other.
In the embodiment given above, an example was described in which the abutting portion 38 is provided to extend from an end portion of the protruding portion 36a of the lock arm 36 in a leading end direction of the second housing 32. However, the configuration is not limited thereto. For example, the abutting portion 38 may be provided at a position slightly closer to a rear end of the second housing 32 relative to the end portion of the protruding portion 36a in the leading end direction of the second housing 32.
In the embodiment given above, an example was described in which the abutting portion 38 is provided to extend along the extending portion 36b from the end portion of the protruding portion 36a in the leading end direction of the second housing 32. However, the configuration is not limited thereto. For example, the abutting portion 38 may be provided only in the protruding portion 36a. That is, a configuration is also possible in which the abutting portion 38 is not provided to extend along the extending portion 36b that extends in the rear end direction of the second housing 32 from the upper portion of the protruding portion 36a.
In the embodiment given above, an example was described in which an end surface of the protruding portion 36a in the leading end direction of the second housing 32 and an upper surface of the protruding portion 36a are connected by a chamfered portion 36e. However, the configuration is not limited thereto. For example, the end surface of the protruding portion 36a in the leading end direction of the second housing 32 and the upper surface of the protruding portion 36a may be connected at a right angle.
In the embodiment given above, an example was described in which the abutting portion 38 is configured to prevent the second housing 32 from coming into contact with the first terminal 23 even when the lock arm 36 is bent. However, the configuration is not limited thereto. A configuration is also possible in which no consideration is given to the state in which the lock arm 36 is bent.
In the embodiment given above, an example was described in which the first housing 22 includes a separation wall 24 that is provided between two first terminals 23 that are provided in the width direction of the first housing 22. However, the configuration is not limited thereto. A configuration is also possible in which the first housing 22 does not include the separation wall 24. In the case where the first housing 22 does not include the separation wall 24, the second housing 32 may not include the separation groove 34. Also, in the embodiment given above, an example was described in which two first terminals 23 are provided in the width direction of the first housing 22. However, the configuration is not limited thereto. Only one first terminal 23 may be provided in the width direction of the first housing 22, or three or more first terminals 23 may be provided in the width direction of the first housing 22.
In the embodiment given above, an example was described in which the separation wall 24 includes an auxiliary wall 25 that extends in the width direction of the first housing 22 toward between two first terminals 23 that are provided in the height direction of the first housing 22. However, the configuration is not limited thereto. A configuration is also possible in which the separation wall 24 does not include the auxiliary wall 25. In the case where the separation wall 24 does not include the auxiliary wall 25, the second housing 32 may not include the auxiliary groove 35. Also, in the embodiment given above, an example was described in which two first terminals 23 are provided in the height direction of the first housing 22. However, the configuration is not limited thereto. Only one first terminal 23 may be provided in the height direction of the first housing 22, or three or more first terminals 23 may be provided in the height direction of the first housing 22.
As shown in FIGS. 5 and 6, the extending portion 36b may extend along the second attachment/detachment direction X2 (the rear end direction of the second housing 32) from the upper portion of the protruding portion 36a in the protruding direction of the protruding portion 36a. As shown in FIGS. 2, 5, and 6, the abutting portion 38 may extend along the second attachment/detachment direction X2 from the end portion of the protruding portion 36a in the first attachment/detachment direction X1 (the leading end direction of the second housing 32) such that the abutting portion 38 opposes the upper surface 32c of the second housing 32 with a predetermined distance therebetween. As shown in FIGS. 3 and 5, the maximum width dimension in the second axis Y direction of the lock arm 36 including the abutting portion 38 may be smaller than the maximum width dimension in the second axis Y direction of a portion of the second housing 32 located in the first width direction Y1 relative to the separation groove 34. As shown in FIG. 6, the abutting portion 38 may be located in the first attachment/detachment direction X1 relative to the engaging claw 36c.
As shown in FIGS. 2, 5, and 6, the abutting portion 38 may be a bending plate that includes: when the second housing 32 is in a natural state in which the second housing 32 is not inserted in the first housing 22 and the lock arm 36 of the second housing 32 is not elastically bent, an end portion in the first attachment/detachment direction X1 direction or a leading end (a first leading end) in a connector coupling direction; an end portion in the second attachment/detachment direction X2 or a leading end (a second leading end) in a connector decoupling direction; and an intermediate bending position or an intermediate inflection point between the first leading end and the second leading end. The configuration in which the abutting portion 38 is a bending plate that includes the intermediate bending position is advantageous to shorten the shortest length of the abutting portion 38 that can protect the first terminal 23 when the second housing 32 is moved relative to the first housing 22 with the second housing 32 being inclined relative to the first housing 22, as compared with a configuration in which the abutting portion 38 is a flat plate without the intermediate bending position. The bending angle and the shortest length of the bending plate that serves as the abutting portion 38 can be determined to satisfy a constraint that the abutting portion 38 can be provided between the abutting-target portion 27 and the upper wall 22d without interfering with the abutting-target portion 27 and the upper wall 22d as shown in FIG. 7.

### LIST OF REFERENCE NUMERALS

11 Connector assembly
21 First connector
22 First housing
22a Opening
22b Closed portion
22c Bottom wall
22d Upper wall
22e Side wall
22f Through hole
23 First terminal
24 Separation wall
25 Auxiliary wall
26 Locking-target portion
27 Abutting-target portion
28 Symmetric extension portion
31 Second connector
32 Second housing
32a Housing hole
32b Lower surface
32c Upper surface
33 Second terminal
34 Separation groove
35 Auxiliary groove
36 Lock arm
36a Protruding portion
36b Extending portion
36c Engaging claw
36d Operating portion
36e Chamfered portion
37 Protection wall
38 Abutting portion
X First axis
X1 First attachment/detachment direction
X2 Second attachment/detachment direction
Y Second axis
Y1 First width direction
Y2 Second width direction
Z Third axis

1. A connector assembly comprising:
a first connector; and
a second connector,
wherein the first connector includes a first housing and a first terminal that is held in the first housing,
the second connector includes a second housing that is insertable and fittable in the first housing and a second terminal that is held in the second housing and connectable to the first terminal,
the first housing includes a locking-target portion and an abutting-target portion,
the second housing includes a lock arm that is engaged with the locking-target portion while the second housing is inserted and fitted in the first housing,
the lock arm includes an abutting portion that, when the second housing is moved relative to the first housing with the second housing being inclined relative to the first housing, abuts against the abutting-target portion to prevent the second housing from coming into contact with the first terminal,
the lock arm is provided on a side of the second housing in a first width direction that is a one direction that extends along a width direction of the second housing, and
the abutting portion protrudes in a second width direction that is a direction opposite to the first width direction in the lock arm.

2. The connector assembly according to claim 1,
wherein the lock arm includes: a protruding portion that protrudes in a height direction of the second housing from a leading end of the second housing that is inserted into the first housing; an extending portion that extends in a rear end direction of the second housing from an upper portion of the protruding portion; and an engaging claw that protrudes in the height direction of the second housing from the extending portion and is engageable with the locking-target portion, and
the abutting portion is provided to extend from an end portion of the protruding portion in a leading end direction of the second housing.

3. The connector assembly according to claim 2,
wherein the abutting portion is provided to extend along the extending portion from the end portion of the protruding portion in the leading end direction of the second housing.

4. The connector assembly according to claim 2,
wherein an end surface of the protruding portion in the leading end direction of the second housing and an upper surface of the protruding portion are connected by a chamfered portion.

5. The connector assembly according to claim 1,
wherein the abutting portion is configured to prevent the second housing from coming into contact with the first terminal even when the lock arm is bent.

6. The connector assembly according to claim 1,
wherein the first terminal includes two first terminals that are provided in a width direction of the first housing,
the first housing includes a separation wall that is provided between the two first terminals that are provided in the width direction of the first housing,
the second housing includes a separation groove in which the separation wall is inserted while the second housing is inserted and fitted in the first housing, and
the lock arm is provided on the side of the second housing in the first width direction relative to the separation groove.

7. The connector assembly according to claim 6,
wherein the first terminal includes two first terminals that are provided in a height direction of the first housing,
the separation wall includes an auxiliary wall that extends in the width direction of the first housing toward between the two first terminals that are provided in the height direction of the first housing, and
the second housing includes an auxiliary groove in which the auxiliary wall is inserted while the second housing is inserted and fitted in the first housing.
